(19) United States
(12) Patent Application Publication
(10) Pub. No.: US 2004/0093536 A1
(43) Pub. Date: May 13, 2004

(54) System and method for providing coherency during the evaluation of a multiprocessor system

(76) Inventor: Christopher Todd Weller, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/292,274

(22) Filed: Nov. 12, 2002

(51) Int. Cl. G06F 11/26

(52) U.S. Cl. 714/33

(57) ABSTRACT

A system and method for providing data coherency during the evaluation of a multiprocessor system is disclosed. A test vector generator is operable to cause a series of instructions marked with program flow indicators that affect a value stored in a virtual register space to be executed on the multiprocessor system. A progress register is associated with the virtual register space for storing a flag indicative of which instruction is to be executed with respect to the virtual register space.

### BACKGROUND OF THE INVENTION

1. Technical Field of the Invention

The present invention generally relates to multiprocessor systems. More particularly, the present invention is directed to a system and method for providing coherency during the evaluation of a multiprocessor system employing sharing of data.

2. Description of Related Art

Without limiting the scope of the invention, the Background of the Invention is described in connection with systems of microprocessors, as an example. The functional verification of a system of microprocessors is concerned with ensuring a high degree of confidence in the functional quality of the system. More specifically, functional verification of microprocessor systems includes extensive functional testing to diagnose any discrepancies between the design of the microprocessor system and intended functional behavior that affect the performance and electrical characterization of the microprocessor system.

Typically, a simulation-based verification tool, such as a hand-coded test generation tool or a pseudo-random test generation tool, is employed to uncover errors by executing one or more test suites on the microprocessor system and comparing the state of a particular processor under test (PUT) with an expected state after the test suites are applied.

In functional verification, an important metric to monitor is test coverage which is a measure of the completeness of the test suite for a particular hardware platform. Following the execution of a test suite, data is analyzed to determine test coverage and to identify regions of the behavior of the processor system that are not well covered by the verification tool. Usually, verification engineers manually tune the verification tool or write a focused test sequence to supplement the gap in coverage. Typically, such tuning cannot be completely generated by software, but must instead be hand-coded by a verification engineer familiar with the target processor system. In addition to hand coding the focused test sequence, the verification engineer must determine the proper expected state of the test sequence from the PUT.

The foregoing concerns relating to the functional verification of a processor system become particularly significant where multiple processors are configured into a unified multiprocessor (MP) system such as, e.g., a symmetrical MP (SMP) system, an asymmetrical MP (AMP) system, et cetera, wherein the MP system is designed to support true sharing of data. As is well known, true data sharing between multiple processors in an MP system involves the loading and storing of data at the same address in memory by at least two different processors. Whereas it is relatively straight forward to generate test suites that can effectuate data sharing, the correct determination of the test's outcome can be very difficult.

Referring now to FIG. 1, a program flow mapping table 100 illustrates the deficiency of a prior art solution for verifying an MP system employing true sharing. In particular, program flow mapping table 100 illustrates the value of a variable A stored in a register 102 as a function of time, which tracks the execution flow of three illustrative instructions (i.e., test code) 112, 114, and 116. The multiprocessor system includes processor 104 and processor 106. The test vector code executes instruction set 108 and instruction set 110 on processor 104 and processor 106, respectively. Instruction set 108 includes instruction 112 for assigning the value of 6 to A and instruction 114 for adding 3 to the value of A in register 102. Instruction set 110 includes instruction 116 for multiplying the value of register A by zero.

If the intended execution order of the test instructions is followed (i.e., instruction 112→instruction→116 instruction 114), the expected outcome is to obtain a value of 3 for the variable A stored in the register. In the current MP arrangements, however, the program execution flow can be indeterminate and, therefore, a different execution order may result. Accordingly, it is possible that the instructions 112-116 are executed in an incorrect order. For example, processor 104 executes instruction 112 by assigning a value of 6 to A in stage 1. Processor 104 then proceeds to execute instruction 114 in stage 3 before processor 106 can execute instruction 114. Therefore, the resulting value of A in register 102 is 0 and the test vector presents a false error.

### SUMMARY OF THE INVENTION

A system and method for providing data coherency during the evaluation of a multiprocessor system is disclosed. A test vector generator is operable to cause a series of instructions marked with program flow indicators that affect a value stored in a virtual register space to be executed on the multiprocessor system. A progress register is associated with the virtual register space for storing a flag indicative of which instruction is to be executed with respect to the virtual register space.

### BRIEF DESCRIPTION OF THE DRAWINGS

A more complete understanding of the present invention may be had by reference to the following Detailed Description when taken in conjunction with the accompanying drawings wherein:

FIG. 1 (Prior Art) depicts an embodiment of a program flow mapping table associated with a prior art solution for executing test code on an MP system employing data sharing;

FIG. 2 depicts a flow chart of the various operations involved in one embodiment of a method for providing data sharing coherency during the evaluation of an MP system;

FIG. 3A depicts a schematic diagram of one embodiment of a system for providing coherency during the evaluation of an MP system under test;

FIG. 3B depicts a schematic diagram of one embodiment of the shared memory structure employed by the MP system of FIG. 3A;

FIG. 4 depicts a flow chart of the various additional operations involved in a particular embodiment of the method shown in FIG. 2;

FIG. 5A depicts an embodiment of a program flow table illustrating the coherency of an MP system under test employing true sharing in accordance with the teachings of the present invention;

FIG. 5B depicts a flow chart of the various operations performed by a processor of FIG. 5A;

FIG. 5C depicts a flow chart of the various operations performed by another processor of FIG. 5A; and

FIG. 6 depicts an embodiment of a program flow mapping table illustrating the coherency of another MP system under test employing true sharing.

### DETAILED DESCRIPTION OF THE DRAWINGS

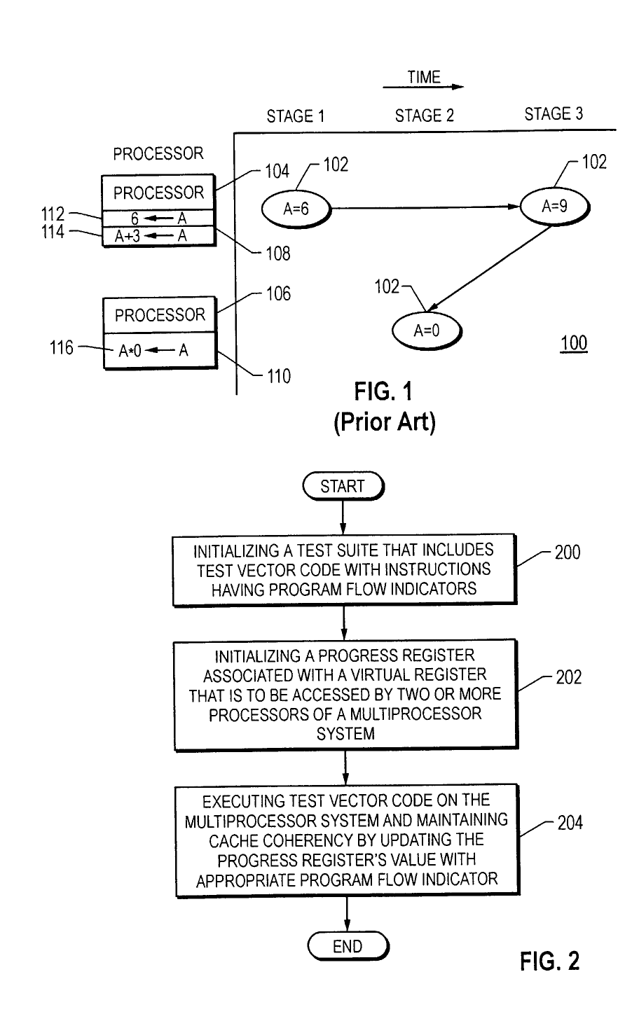

In the drawings, like or similar elements are designated with identical reference numerals throughout the several views thereof, and the various elements depicted are not necessarily drawn to scale. Referring now to FIG. 2, depicted therein is a flow chart of the various operations involved in one embodiment of a method for providing coherency during the evaluation of a multiprocessor system so that true sharing of data is achieved. At block 200, a test suite that includes test vector code with instructions having program flow indicators, as will be described in detail below, is initialized. The program flow indicators indicate the order in which the instructions are to be executed. In one embodiment, a test generator, which may comprise any combination of hardware, software, and firmware, generates the test suite.

At block 202, a progress register associated with a virtual register that is to be accessed by two or more processors of the MP system is initialized. The value of the progress register is indicative of the progress and synchronization of the instructions of the test vector code. The value of the program flow indicators and progress register may be a member of the set U such that u₁ ∈ {u₁, u₂, u₃, u₄, u₅, . . . } wherein each element may be any number. In one embodiment, the set U indicates the order in which the instructions are to be executed. For example, the instruction or instructions having a program flow indicator of u₁ are executed first. Next, the instruction or instructions having a program flow indicator of u₂ are executed, and so on. The value of the progress register indicates which instruction should be executed. The value of the progress register may be initialized to u₁, for example. In one embodiment, to prevent multiple instructions of the test vector from executing at the same time (e.g., in order to write data into a shared memory location), each member u₁ has a distinct value, that is, for example, u₁≠u₂≠u₃. In one embodiment, the value of the progress register is selected from a predetermined set of distinct, randomly generated numbers. For example, the value of the progress register may be selected from the set U′ wherein uᵢ′ ∈ {3, 5000, 45, 63, 9, 287 . . . }.

At block 204, the test vector code is executed on the MP system and in particular on two or more processors under test (PUTs). Following the execution of its instruction or instructions, each PUT updates the value of the progress register to the next value in the set. For example, following the execution of instruction or instructions having a program flow indicator of u₁, the PUT updates the value of the progress register to u₂. Data coherency is accordingly maintained by executing the instructions in a predetermined, specified order based on the program flow indicator and progress register's value.

The processor under test may be any processor within the multiprocessor system. As will be discussed in more detail hereinbelow, the test vector verifies the functionality of the processor under test by performing extensive functional testing to ensure that the design of the multiprocessor system implements the intended functional behavior. The processors of the MP system may include processors of any design for which evaluation information is desired; for instance, complex instruction set computation (CISC) processors, reduced instruction set computation (RISC) processors, simputers, graphic processor units, and the like may be employed in the practice of the present invention.

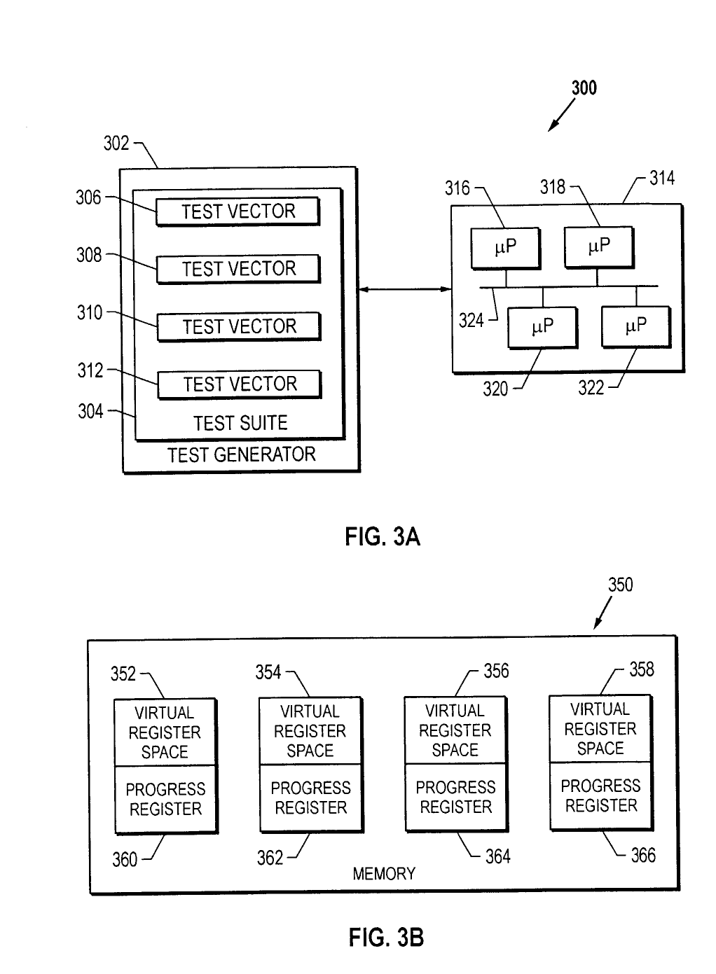

FIG. 3A depicts one embodiment of a system 300 for providing coherency during the evaluation of an MP system. A test generator 302 employing a verification technique includes a test suite 304 having test vectors 306-312. The test vectors 306-312 may be developed using a variety of simulation-based verification tools such as hand-coded test generation, pseudo-random test generation, or template-based test generation. For example, a pseudo-random test generator may be employed that incorporates knowledge about the operational environment, the processor architecture, and test vector architecture to create a matrix of parameters that allow the verification engineer to bias test vector generation to increase test coverage.

A microprocessor system 314 that includes four microprocessors under test 316-322 is coupled to the test generator 302 by any conventional technique. A system bus 324 couples the four microprocessors under test 316-322 together. As illustrated, the microprocessors under test 316-322 are conventional microprocessors which perform arithmetic, logic and control operations with the assistance of internal memory; however, as previously discussed, other devices are within the teachings of the present invention. Moreover, although a system of four microprocessors is illustrated, it should be appreciated that the system may comprise any number of microprocessors.

In an operational embodiment, after the test generator 302 has generated the test suite 304 and stored the test suite in internal memory, the test generator 302 causes the microprocessors 324-330 to execute test vectors 306-312, respectively. Alternatively, the test vector execution could be staged. Each test vector comprises one or more instruction sets comprising instructions marked by a program flow indicator. In one embodiment, the architecture of a test vector may take the following form:

instruction set_1

instruction_{—}1[parameters]; [program flow indicator]

instruction_{—}2[parameters]; [program flow indicator]

instruction_{—}3[parameters]; [program flow indicator]

.

.

.

instruction_n [parameters]; [program flow indicator]

.

.

.

instruction set_n

instruction_{—}1[parameters]; [program flow indicator]

instruction_{—}2[parameters]; [program flow indicator]

instruction_{—}3[parameters]; [program flow indicator]

+P2

+P2

+P2

instruction_n [parameters]; [program flow indicator]

Each instruction is marked with a program flow indicator to provide synchronization and data coherency to the verification process as discussed in further detail below. In one implementation, a portion of the instructions affect a value stored in a virtual memory location (e.g., a register) that is a part of the shared memory structure distributed in the multiprocessor system 300.

The outcome of the verification tests performed by the test generator 302 may be determined by comparing the virtual location's value with an expected value after the test suite 304 is applied. Typically, manual inspection, self-check testing or other inspection techniques may also be employed with respect to verifying processor states. In manual inspection, the state output is inspected through an interface, such as a logic analyzer. Manual inspection can be very tedious and time consuming, and is best reserved for diagnosing the root cause of detected discrepancies. In self-checking tests, the PUT's final state is compared to a predetermined final state. The outcome of the self-checking test is a pass or fail. In general, a combination of manual inspection and self-checking is employed. Self-checking is used to determine whether and where the errors occurred and manual inspection is used to diagnose the root cause of the error.

Referring now to FIG. 3B, wherein one embodiment is depicted of a shared memory structure 350 employed by the MP system 314 of FIG. 3A. The shared memory structure 350 may be distributed in any manner in the MP system and can be comprised of a plurality of shareable virtual spaces 352-358. Each virtual space 352-358 includes one or more virtual locations (e.g., registers) wherein data may be stored. In accordance with the teachings of the present invention, progress registers 360-366 are associated with register spaces 352-358, respectively. Each progress register 360-366 is operable to store a flag indicative of the synchronization of instruction execution with respect to the virtual register space associated therewith.

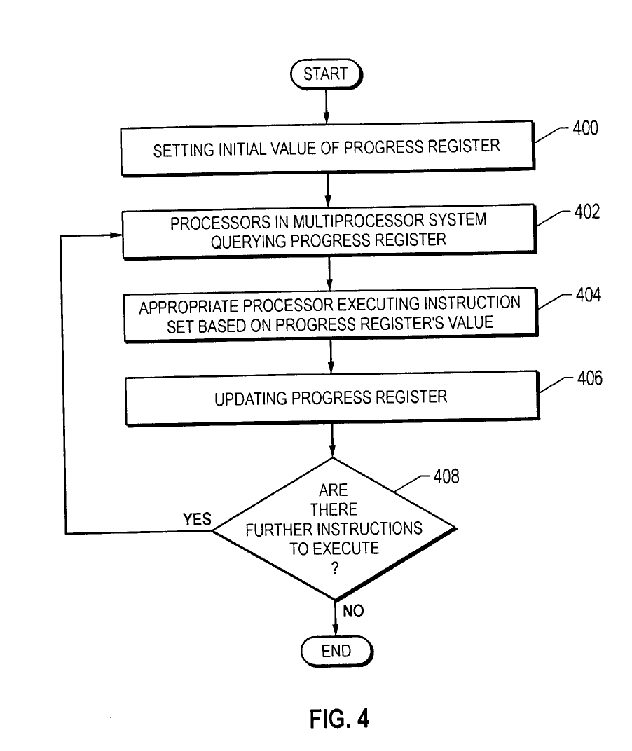

FIG. 4 depicts the various additional operations involved in a particular embodiment of the method shown in FIG. 2, wherein one virtual register and its progress register is employed for purposes of illustration. At block 400, the initial value of the progress register is set. At block 402, the processors in the multiprocessor system query the progress register. Each processor is able to read the progress register, however, only a processor having control of the virtual register is able to write to the progress register. In one embodiment, processor control over the virtual register may be implemented using semaphores. At block 404, based on the progress register's value, the appropriate processor or processors execute an instruction set. At block 406, the progress register is updated by a processor that has control of the virtual register. The instruction for updating the progress register may be included in the instruction or the program flow indicator, for example. In one embodiment, the flag stored in the progress register is updated by incrementing. At decision block 408, if further instructions require execution, the flow returns to block 402 as illustrated by a return path. If there are no further instructions requiring execution, however, the execution of the test vector code is complete and the data collected can be analyzed to determine the functional verification of the multiprocessor system.

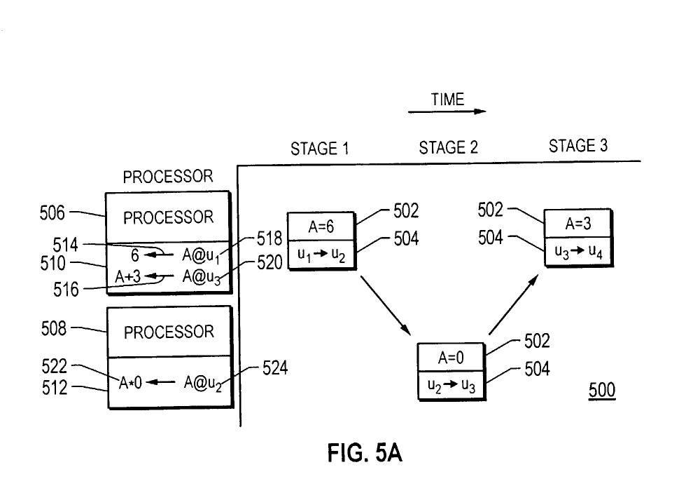

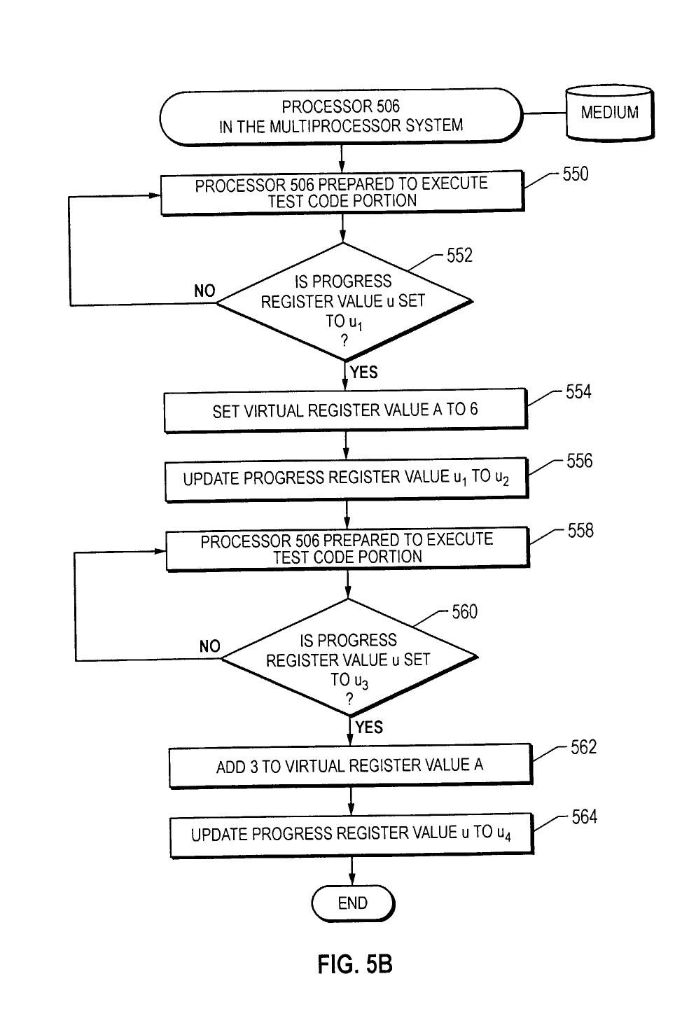

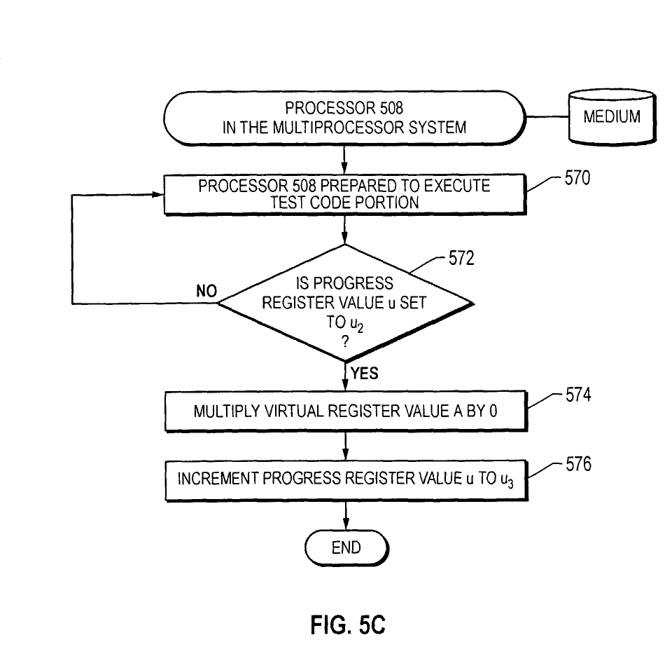

Referring now to FIG. 5A, depicted therein is an embodiment of a program flow mapping table 500 illustrating the coherency of an MP system under test that employs true sharing of data in accordance with the teachings of the present invention. The value of A is stored in a virtual register 502. A progress register 504 is associated with the virtual register 502. A flag, depicted as a member of the set U such that u₁ ∈ {u₁, u₂, u₃, u₄, U₅, . . . }, is stored in progress register 504 as an indicator of which instruction is to be executed with respect to virtual register 502. The value of A stored in virtual register 502 and the flag stored in progress register 504 are depicted in the mapping table 500 as a function of time.

The illustrative multiprocessor system includes processor 506 and processor 508. A test vector includes instruction set 510 and instruction set 512 executable on processor 506 and processor 508, respectively. Instruction set 510 includes instruction 514, i.e. 6←A, for assigning the value of 6 to A and instruction 516, i.e. A+3←A, for adding 3 to the value of A in register 502. Program flow indicator 518, i.e. @u₁, marks instruction 514 to indicate that it can be executed when the progress register contains u₁. Similarly, program flow indicator 520, i.e. @u₃, marks instruction 516. Instruction set 512 includes instruction 522, i.e. A*0←A, for multiplying the value of A by zero. Program flow indicator 524, i.e. @u₂, marks instruction 522.

The ability of the test vector to functionally verify the multiprocessor system depends on the processors employing the execution order, i.e., instruction 514→instruction 522→instruction 516, to provide a value stored register A of 3. At the outset (i.e., stage 0), the flag of progress register 504 is initialized to a value of u₁. Processors 506 and 508 query the value of the flag. Instruction 514 is marked with program flow indicator 508 which has a value, u₁, that corresponds to the value of the flag. Accordingly, processor 506 executes instruction 514 assigning a value of 6 to A stored in virtual register 502. Processor 506 then updates the flag value to u₂. Processors 506 and 508 again query the value of the flag. As the flag now has a value of u₂, processor 508 proceeds to execute instruction 522, thereby changing the value of A to 0. Processor 506 does not attempt to execute instruction 516 since the program flow indicator 520 and flag of progress register 504 have non-corresponding values. After executing instruction 522, processor 508 updates the flag of progress register 504 from u₂ to u₃, which is the next value in the set U. In stage 3, processors 506 and 508 query the value of the flag again and processor 506 executes instruction 516 as the value of program flow indicator 520 corresponds to the value of the flag. Therefore, the resulting value of A in register 502 is 3, which is the intended outcome of the test vector code employed with respect to the processors 506 and 508.

FIG. 5B illustrates a flow chart of the various operations performed by processor 506 of FIG. 5A. At block 550, the processor is prepared to execute its test vector code. At decision block 552, the processor queries the flag of the progress register. If the value of the flag is u₁, then the operation continues to block 554. If the value of the flag is not u₁, then the operation returns to block 550. At block 554, the processor executes an instruction which sets the value of A to 6. At block 556, the processor updates the value of the flag in the progress register to u₂. At block 558, the processor is prepared again to execute another instruction of its test code portion, which instruction has a program flow indicator of u₃. At decision block 560, the processor queries the flag of the progress register. If the value of the flag is u₃, then the operation continues to block 562. Otherwise, the operation returns to block 558. At block 562, the processor executes the instruction and adds 3 to the value of A stored in the virtual register. At block 564, the processor updates the flag of the progress register to the next value, i.e., u₄.

Similar to FIG. 5B, FIG. 5C depicts a flow chart of the various operations performed by processor 508 of FIG. 5A. At block 570, the processor is prepared to execute its test vector code portion. At decision block 572, the processor queries the flag of the progress register. If the value of the flag is u₂, then the operation continues to block 574. If the value of the flag is not u₂, then the operation returns to block 570. At block 574, the processor executes an instruction (having a program flow indicating u₂) which sets the value of A to zero in a multiplying operation. At block 576, the processor updates the value of the flag in the progress register to u₃.

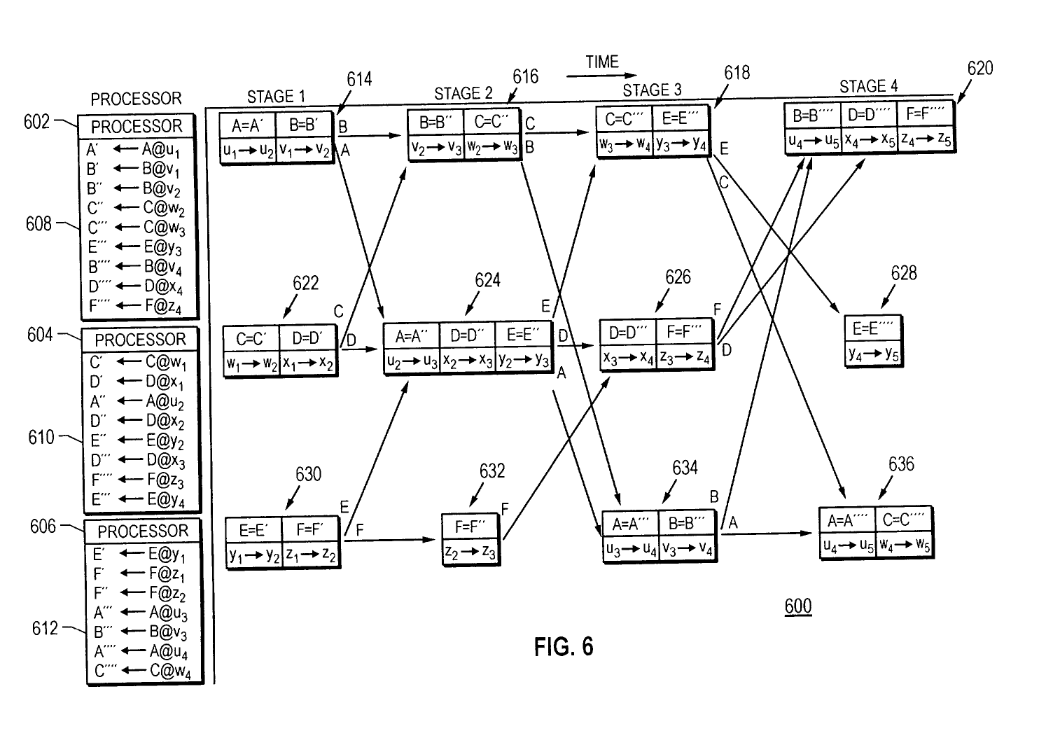

Referring now to FIG. 6, depicted therein is an embodiment of a program flow mapping table 600 illustrating the coherency of another MP system under test that employs true sharing. As previously discussed, the scheme of the present invention may be employed in a system having any number of instructions to be executed on any number of processors. By way of example, table 600 illustrates an embodiment of the present invention being employed on a system of three processors, 602, 604, and 606, each having an instruction set of a plurality of instructions marked with corresponding program flow indicators. By way of illustration, instruction set 608 having 9 instructions is operable to be executed on a processor 602. Likewise, instruction set 610 (8 instructions) and instruction set 612 (7 instructions) are provided for processors 604 and 606, respectively. Reference numerals 614-636 illustrate temporal transitions of six virtual registers having values A through F and corresponding progress register values u through z as they change over four stages of execution flow. For example, the virtual register having the value of E is changed through four instructions executed at temporal transitions 630 (stage 1), 624 (stage 2), 618 (stage 3), and 628 (stage 4). The value of E is changed from E′ to E″ to E′″ to E″″ as four instructions are executed in the following predetermined order:

E′ [symbol] E@y₁ (processor 3),

E″ [symbol] E@y₂ (processor 2),

E′″ [symbol] E@y₃ (processor 1), and

E″″ [symbol] E@y₄ (processor 2).

Based on the foregoing, it should be appreciated that the present invention advantageously provides a system and method for supporting coherency during the evaluation of a multiprocessor system. By associating a progress register having a flag indicative of the test vector synchronization with a virtual register space and marking each instruction with a program flow indicator, the present invention insures that test code is executed in the correct order and, therefore, data coherency is accordingly maintained with respect to the shared memory space of an MP platform.

Although the invention has been described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A system for providing coherency during the evaluation of a multiprocessor system, comprising:
a test vector generator for generating test vector code to be executed by said multiprocessor system, said test vector code operating to cause at least two processors of said multiprocessor system to perform operations affecting a value stored in a virtual register space, wherein said test vector code executing on said at least two processors includes instructions marked by a program flow indicator; and
a progress register associated with said virtual register space for storing a flag indicative of which instruction is to be executed with respect to said virtual register space, wherein said flag is operable to be updated by a processor that has ownership of said virtual register space for an operation.

2. The system as recited in claim 1, wherein said test vector generator employs a testing technique selected from the group consisting of hand-coded test generation, pseudo-random test generation, and template-based test generation.

3. The system as recited in claim 1, wherein said at least two processors are selected from the group consisting of complex instruction set computation (CISC) processors, reduced instruction set computation (RISC) processors, and graphic processor units.

4. The system as recited in claim 1, wherein said virtual register space comprises a shared memory component of said multiprocessor systems.

5. The system as recited in claim 1, wherein said progress register comprises a shared memory component of said multiprocessor systems.

6. The system as recited in claim 1, wherein said progress register comprises a plurality of memory locations.

7. The system as recited in claim 1, wherein said virtual register space comprises a plurality of memory locations.

8. The system as recited in claim 1, wherein said flag comprises a value selected from a predetermined set of randomly generated numbers.

9. The system as recited in claim 1, wherein said flag is operable to be updated via incrementing by said processor that has ownership of said virtual register space for said operation.

10. A method for providing coherency during the evaluation of a multiprocessor system employing true sharing, comprising:
initializing at least one test vector, said at least one test vector operating to affect a value stored in a virtual register;
querying a value of a progress register associated with said virtual register, wherein said value of said progress register is indicative of an instruction of said at least one test vector;
executing an instruction of said at least one test vector depending on said value of said progress register; and
updating said value of said progress register.

11. The method as recited in claim 10, wherein said operation of querying a value of a progress register associated with said virtual register further comprises comparing the value of said progress register and value of a program flow indicator of said instruction.

12. The method as recited in claim 10, wherein said operation of updating said value of said progress register further comprises incrementing said value of said progress register by a processor having ownership of said virtual register for an operation.

13. The method as recited in claim 10, wherein said value of said progress register comprises a predetermined random number.

14. A computer-accessible medium having instructions for evaluating a multiprocessor system that employs true data sharing, said instructions which, when executed on said multiprocessor system, perform the operations:
executing an instruction of a test suite on a processor of said multiprocessor system for affecting a value stored in a shareable location, wherein said instruction is marked with a program flow indicator indicative of said instruction's sequence in said multiprocessor system's execution flow of said test suite; and
updating a flag stored in a progress register associated with said virtual register, said flag for identifying which instruction of said test suit is to be executed with respect to said virtual register.

15. The computer-accessible medium as recited in claim 14, further comprising instructions for comparing said flag stored in said progress register and a value of said program flow indicator.

16. The computer-accessible medium as recited in claim 14, wherein said flag of said progress register comprises a predetermined random number.
